(19) United States
(12) Patent Application Publication
(10) Pub. No.: US 2019/0147476 A1
(43) Pub. Date: May 16, 2019

(54) APPARATUS, SYSTEM, AND METHOD FOR INTEGRATING POINT CARD

(71) Applicant: TOSHIBA TEC KABUSHIKI KAISHA, Tokyo (JP)

(72) Inventor: Kazuyuki Imura, Izu Shizuoka (JP)

(21) Appl. No.: 16/185,075

(22) Filed: Nov. 9, 2018

(30) Foreign Application Priority Data
Nov. 15, 2017 (JP) 2017-220035

(51) Int. Cl. G06Q 30/02; G06K 7/14; G06Q 20/20

(52) U.S. Cl. CPC G06Q 30/0226; G06Q 20/209; G06Q 20/202; G06K 7/1413

(57) ABSTRACT

In accordance with an embodiment, a point card integration apparatus comprises a reading module configured to read an integration source point card and an integration object point card; an acquiring module configured to acquire retained points stored respectively in association with the integration source point card and the integration object point card read by the reading module; a calculation module configured to calculate a total point obtained by adding up the retained point of the integration source point card and the retained point of the integration object point card which are acquired by the acquiring module; and an update module configured to update the retained point associated with the integration object point card to the total point, and then to set the retained point associated with the integration source point card to zero point.

### CROSS-REFERENCE TO RELATED APPLICATION

This application is based upon and claims the benefit of priority from Japanese Patent Application No. 2017-220035, filed Nov. 15, 2017, the entire contents of which are incorporated herein by reference.

### FIELD

Embodiments described herein relate generally to an apparatus, a system, and a method for integrating point cards.

### BACKGROUND

There is a type of point card system for recording a point on a card and a type of point card system for recording a point in a server. In the latter case, the server is provided with a point database that stores the point in association with a card ID for identifying a point card. Then, if an inquiry command including a card ID of a point card from a terminal having a function of reading the point card is received, the server reads out the point associated with the card ID from the point database and notifies the terminal. If an update command including the card ID of the point card and a point after change from the terminal, the server rewrites the point associated with the card ID in the point database with the point after change.

If one customer who uses such a point card system possesses a plurality of point cards, it is convenient to integrate the point of each point card on one point card. In the conventional terminal, it is possible to integrate the points in plural point cards on one point card by the following procedures.

First, a user of the terminal sets an operation mode of the terminal to an inquiry mode. The user then uses a card reader of the terminal to read an integration source point card. By this operation, an inquiry command including a card ID of the integration source point card is transmitted from the terminal to the server, and the point associated with the card ID is notified from the server to the terminal, and thus, the user can confirm the point of the integration source point card.

Next, the user uses the card reader to read an integration object point card while maintaining the inquiry mode as the operation mode of the terminal. By this operation, an inquiry command including a card ID of the integration object point card is transmitted from the terminal to the server, and the point associated with the card ID is notified from the server to the terminal, and thus, the user can also confirm the point of the integration object point card.

The user adds up the point of the integration source point card and the point of the integration object point card. Then, the user switches the operation mode of the terminal to an update mode, uses the card reader of the terminal to read the integration object point card, and manually inputs a total point as a point after change. By this operation, an update command including the card ID of the integration object point card and the point after change is transmitted from the terminal to the server. As a result, the point associated with the card ID of the integration object point card managed in the database is updated to the point after change.

While maintaining the update mode as the operation mode of the terminal, the user uses the card reader to read the integration source point card and manually inputs zero as the point after change. By this operation, an update command including the card ID of the integration object point card and the point after change is transmitted from the terminal to the server. As a result, the point associated with the card ID of the integration source point card managed in the database is updated to zero point.

As described above, in the conventional point card system, at the time of integrating the points in a plurality of point cards on one point card, it is necessary to read out both data of the integration source point card and data of the integration object point twice. Since it is necessary to manually input the total point and zero point, the operation becomes complicated, and a mistake easily occurs. Furthermore, there is a problem that a procedure of setting the point of the integration source point card to zero point is easily forgotten, resulting in inconsistency in the total number of points in the whole system.

### DESCRIPTION OF THE DRAWINGS

FIG. 1 is a diagram schematically illustrating a configuration of a POS system according to an embodiment;

FIG. 2 is a schematic diagram illustrating a main data structure of a point record stored in a point database;

FIG. 3 is a block diagram illustrating a circuit configuration of main portions of a POS server;

FIG. 4 is a block diagram illustrating a circuit configuration of main portions of a POS terminal;

FIG. 5 is a schematic diagram illustrating a main memory area of a main memory of the POS terminal;

FIG. 6 is a flowchart depicting a first half of procedures of an information processing executed by a processor of the POS terminal executing a point card integration program;

FIG. 7 is a flowchart depicting a second half of procedures of the information processing executed by the processor of the POS terminal executing the point card integration program;

FIG. 8 is a flowchart depicting main procedures of a reception interruption processing executed by the processor of the POS server;

FIG. 9 is a diagram illustrating an example of a customer reservation-oriented receipt issued from the POS terminal at the time of integrating point cards; and

FIG. 10 is a diagram illustrating an example of a store reservation-oriented receipt issued from the POS terminal at the time of integrating point cards.

### DETAILED DESCRIPTION

In accordance with an embodiment, a point card integration apparatus comprises a reading module configured to read an integration source point card and an integration object point card; an acquiring module configured to acquire retained points stored respectively in association with the integration source point card and the integration object point card read by the reading module; a calculation module configured to calculate a total point obtained by adding up the retained point of the integration source point card and the retained point of the integration object point card which are acquired by the acquiring module; and an update module configured to update the retained point associated with the integration object point card to the total point, and then to set the retained point associated with the integration source point card to zero point.

Hereinafter, an embodiment is described with reference to the accompanying drawings.

In the embodiment, a POS system built in a supermarket, a department store, a chain store, etc. functions as a point card integration system, and a POS (point of sales) terminal installed in a retail store functions as a point card integration apparatus. The integration of the point cards is to integrate points in a plurality of point cards on one point card. In the embodiment, one of the two point cards of the same type is set as an integration source point card while the other as an integration object point card, and a point of the integration source point card is integrated into a point of the integration object point card.

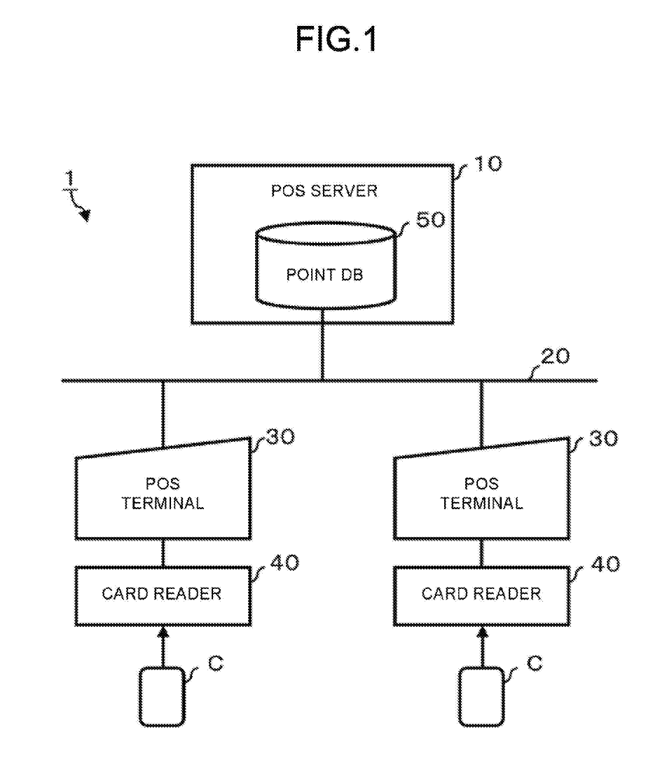

FIG. 1 is a diagram schematically illustrating a configuration of a POS system 1 according to the present embodiment. The POS system 1 includes a POS server 10 and a plurality of POS terminals 30 connected to the POS server 10 via a network 20. The network 20 is a wired LAN (Local Area Network), a wireless LAN, or the like. The network 20 may be configured by combining the wired LAN or the wireless LAN with a wide area network such as the Internet, a telephone network or the like.

The POS server 10 manages sales, inventory, etc. of the whole retail store based on data collected from each POS terminal 30 via the network 20. The POS server 10 may be a store server provided in one retail store or may be a headquarters server provided in headquarters that collectively supervises a plurality of retail stores. The POS server 10 may be a cloud server (cloud computing) formed in a cloud environment.

The POS terminal 30 performs a processing of registering sales data of a commodity to be purchased by a customer. Then, the POS terminal 30 calculates a price of one transaction for the customer based on the sales data of the commodity, and performs a processing of settling the price of the transaction by receiving payment for the price.

Such a POS system 1 can use hardware of an existing POS system without any change.

In the present embodiment, the following point service is applied in the retail store. Specifically, a store clerk in the retail store issues a point card C to a customer who is a point member. The point member shops in the retail store and then presents the point card C to a store clerk who is an operator of the POS terminal 30 at the time of checkout. The store clerk in the retail store gives the point according to contents of the transaction for the point member. Then, the store clerk in the retail store accumulates the point given to each point card C. The point member can exchange the accumulative point as appropriate for privileges such as a discount, a free gift, etc.

In order to handle such a point service, each POS terminal 30 is provided with a card reader 40 capable of reading data of the point card C. The card reader 40 may be integrated with the POS terminal 30 or may be independent of the POS terminal 30. In the point card C, a unique card ID as card identification information is recorded. In other words, the point card C can be individually identified by the card ID recorded therein. The point card C may further store data in addition to the card ID.

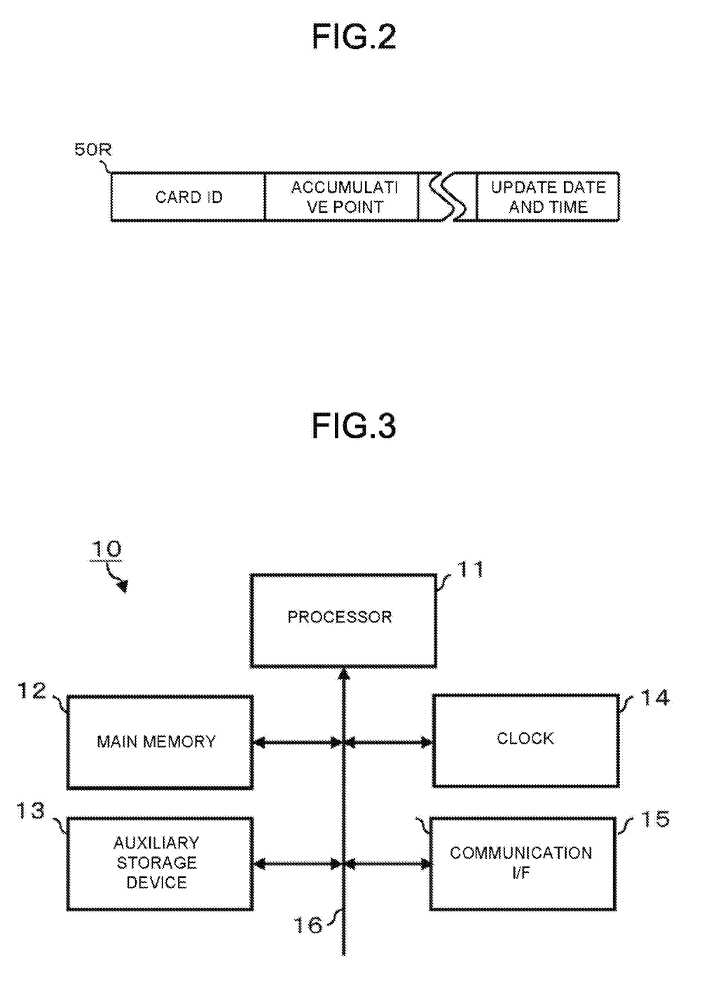

On the other hand, the POS server 10 has a point database 50 for storing a point record 50R (refer to FIG. 2) created for each point card C. FIG. 2 is a schematic diagram illustrating a main data structure of the point record 50R. As shown in FIG. 2, the point record 50R includes data of each of the card ID, an accumulative point and an update date and time. The card ID is identification information of the point card C issued to the point member. The accumulative point is a point retained in the point card C identified by the card ID. The accumulative point is added with the number of given points when the point is given to the point member. The accumulative point is subtracted by the number of points for exchange when the point member exchanges the point for the privilege. The update date and time is the latest date and time when the accumulative point is updated.

FIG. 3 is a block diagram illustrating a circuit configuration of main portions of the POS server 10. The POS server 10 includes a processor 11, a main memory 12, an auxiliary storage device 13, a clock 14, a communication interface 15, and a system bus 16. In the POS server 10, the processor 11, the main memory 12, the auxiliary storage device 13, the clock 14 and the communication interface 15 are connected to the system bus 16 directly or via a signal input/output circuit. In the POS server 10, the processor 11, the main memory 12 and the auxiliary storage device 13, and the system bus 16 connecting them constitute a computer.

The processor 11 acts as a central part of the computer. The processor 11 executes an operating system and an application program to control each section to realize various functions of the POS server 10.

The main memory 12 acts as a main memory portion of the computer. The main memory 12 includes a nonvolatile memory area and a volatile memory area. The main memory 12 stores the operating system and the application program in the nonvolatile memory area. The main memory 12 may store data required to for the processor 11 to execute a processing to control each section in the nonvolatile memory area or the volatile memory area in some cases. The main memory 12 uses the volatile memory area as a work area in which the data is appropriately rewritten by the processor 11.

The auxiliary storage device 13 acts as an auxiliary storage portion of the computer. The auxiliary storage device 13 is, for example, an EEPROM (electric erasable programmable read-only memory), an HDD (hard disc drive), an SSD (solid state drive), or the like. The auxiliary storage device 13 stores data used by the processor 11 to perform various processing and data generated in a processing executed by the processor 11. The auxiliary storage device 13 may also store the application program in some cases. The auxiliary storage device 13 stores the point database 50 described above.

The clock 14 functions as a time information source of the POS server 10. The processor 11 counts current date and time based on the time information counted by the clock 14.

The communication interface 15 is connected to the network 20 to perform data communication with each POS terminal 30 via the network 20 in conformity with a predetermined communication protocol.

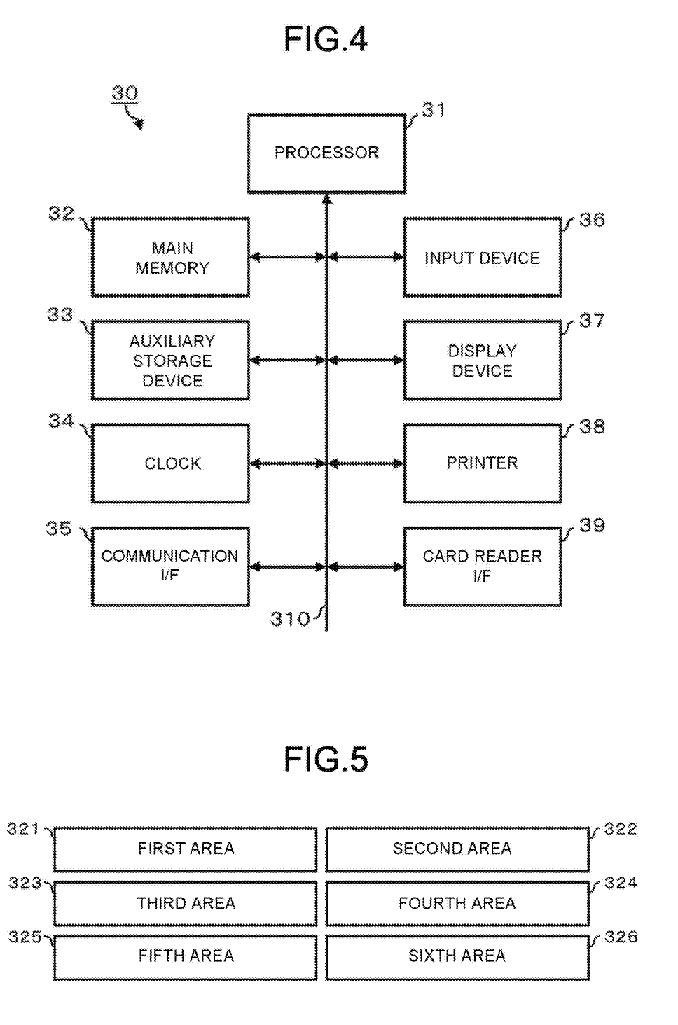

FIG. 4 is a block diagram illustrating the circuit configuration of main portions of the POS terminal 30. The POS terminal 30 includes a processor 31, a main memory 32, an auxiliary storage device 33, a clock 34, a communication interface 35, an input device 36, a display device 37, a printer 38, a card reader interface 39, and a system bus 310. In the POS terminal 30, the processor 31, the main memory 32, the auxiliary storage device 33, the clock 34, the communication interface 35, the input device 36, the display device 37, the printer 38 and the card reader interface 39 are connected to the system bus 310 directly or via a signal input/output circuit. In the POS terminal 30, the processor 31, the main memory 32 and the auxiliary storage device 33, and the system bus 310 connecting them constitute a computer.

The processor 31 acts as a central part of the computer. The processor 31 executes an operating system and an application program to control each section to realize various functions of the POS terminal 30.

The main memory 32 acts as a main memory portion of the computer. The main memory 32 includes a nonvolatile memory area and a volatile memory area. The main memory 32 stores the operating system and the application program in the nonvolatile memory area. The main memory 32 may store data required to for the processor 31 to execute a processing to control each section in the nonvolatile memory area or the volatile memory area in some cases. The main memory 32 uses the volatile memory area as a work area in which the data is appropriately rewritten by the processor 31.

The auxiliary storage device 33 acts as an auxiliary storage portion of the computer. The auxiliary storage device 33 is, for example, an EEPROM, an HDD, an SSD, or the like. The auxiliary storage device 33 stores data used by the processor 31 to perform various processing and data generated in a processing executed by the processor 31. The auxiliary storage device 33 may also store the application program in some cases.

The clock 34 functions as a time information source of the POS terminal 30. The processor 31 counts current date and time based on the time information counted by the clock 34.

The communication interface 35 is connected to the network 20 to perform data communication with the POS server 10 via the network 20 in conformity with a predetermined communication protocol.

The input device 36 receives an input of various instructions from an operator. As the input device 36, known devices such as a touch sensor or a keyboard may be used alone or in combination. A scanner that reads and inputs a barcode attached to a commodity is also included in the input device.

The display device 37 displays various screens for providing the operator with various types of information. As the display device 37, for example, known devices such as a liquid crystal display device may be used.

The printer 38 prints a receipt image indicating contents of the transaction on a receipt paper to issue a receipt.

The card reader interface 39 is connected to a card reader 40 to transmit and receive a data signal to and from the card reader 40.

In order to realize functions of a point card integration apparatus, the POS terminal 30 configured as described above divides a part of the volatile memory area of the main memory 32 into a first area 321, a second area 322, a third area 323, a fourth area 324, a fifth area 325 and a sixth area 326.

The first area 321 is used for storing data of a point card C to be an integration source (hereinafter, referred to as “integration source point card C1”). The second area 322 is used for storing data of a point card C to be an integration object (hereinafter, referred to as an integration object point card C2). The third area 323 is used for storing a point before integration in the integration source point card C1. The fourth area 324 is used for storing a point before integration in the integration object point card C2. The fifth area 325 is used for storing a point after integration in the integration source point card C1. The sixth area 324 is used for storing a point after integration in the integration object point card C2.

The POS terminal 30 stores a point card integration program as a type of an application program to realize the function of the point card integration apparatus. The point card integration program is stored in the main memory 32 or the auxiliary storage device 33. Generally, the transfer of the POS terminal 30 is performed in a state in which various programs including the point card integration program are stored in the main memory 32 or the auxiliary storage device 33. However, the POS terminal 30 may be transferred while these programs are not stored in the main memory 32 or the auxiliary storage device 33 in some cases. In this case, the program is transferred by being recorded on a removable recording medium such as a magnetic disk, a magneto-optical disk, an optical disk, a semiconductor memory or the like. Alternatively, the program may be transferred via a network, and the program may be written in the auxiliary storage device 33 of the POS terminal 30 transferred separately from the program.

The point card integration program is started when the start of execution of a point integration job is instructed via the input device 36. The start of execution of the point integration job is instructed by, for example, a predetermined key operation on a keyboard. Alternatively, the start of execution of the point integration job may be instructed in response to a detection signal from a touch sensor on a job menu displayed on the display device 37. The start of execution of the point integration job may be instructed in response to reading and input of a barcode indicating the point integration job by a scanner.

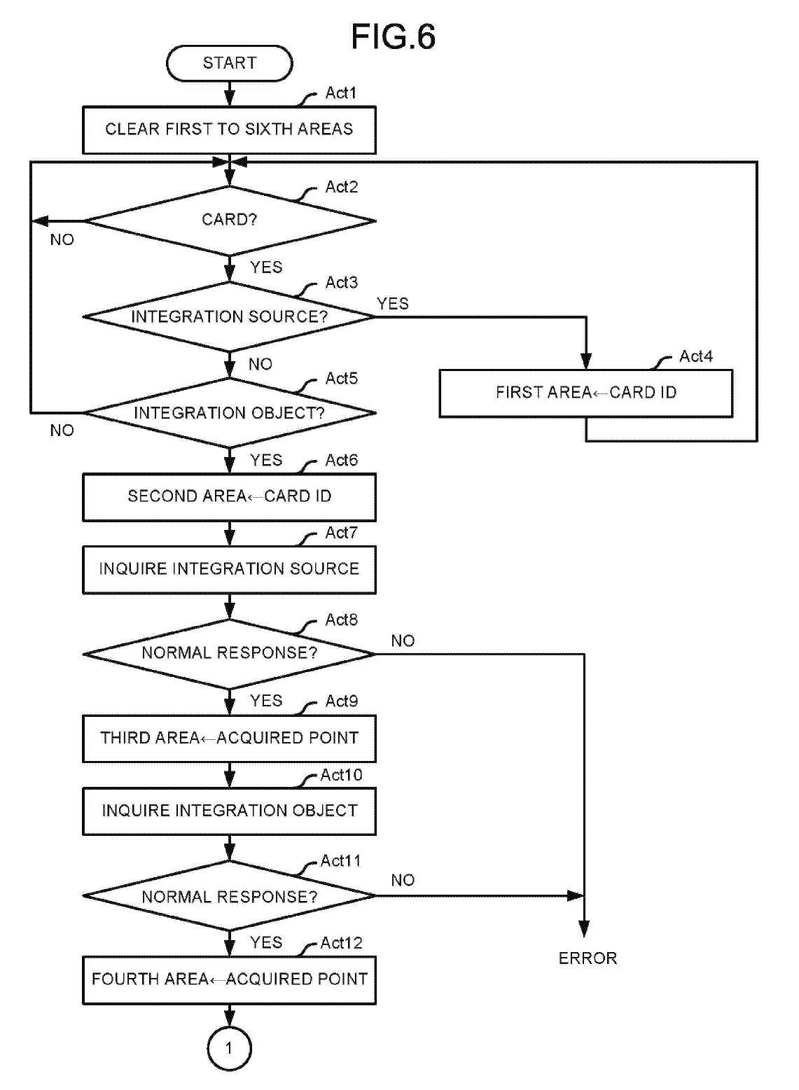

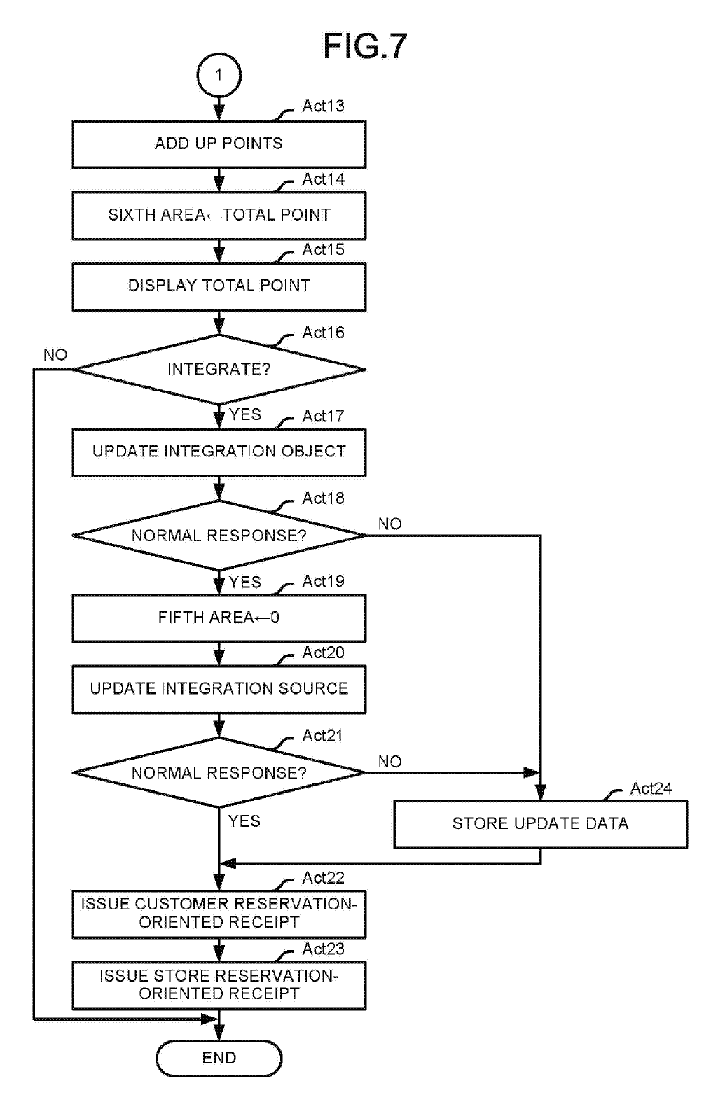

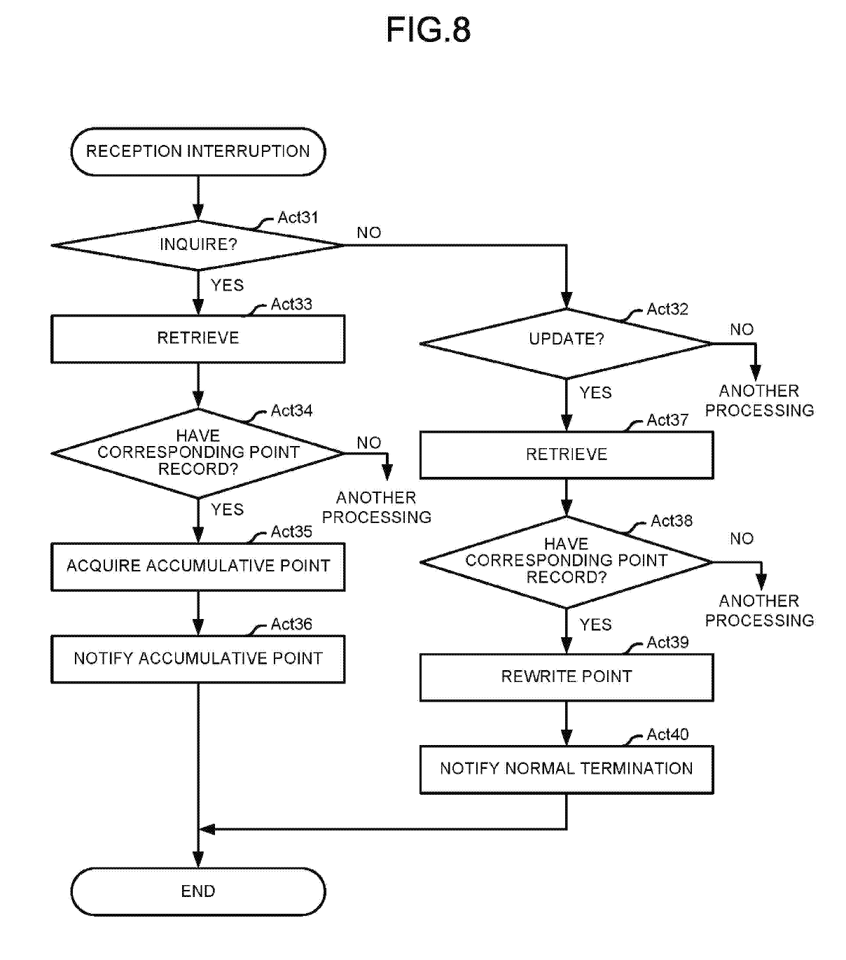

When an operator of the POS terminal 30 receives a request to integrate two point cards into one from a point member, the operator of the POS terminal 30 performs an operation for instructing the start of execution of the point integration job. If the point card integration program is started in response to the operation, the processor 31 of the POS terminal 30 executes an information processing having procedures shown in the flowcharts in FIG. 6 and FIG. 7. In response to reception of a command from the POS terminal 30, the processor 11 of the POS server 10 executes a reception interruption processing shown in the flowchart in FIG. 8. The operation of the POS terminal 30 which is the point card integration apparatus as well as the operation of the POS system 1 which is a point card integration system is described below with reference to FIG. 6 to FIG. 8. The content of the processing described below is merely an example, and various processing capable of achieving the same result can be appropriately used.

First, the processor 31 clears the first to sixth areas 321 to 326 in Act 1. Next, the processor 31 stands by until the data of the point card C is read in Act 2.

If the data of the point card C is acquired via the card reader interface 39, the processor 31 determines that the data of the point card C is read by the card reader 40. If it is determined that the data of the point card C is read (Yes in Act 2), the processor 31 determines whether or not the data of the integration source point card C1 is read in Act 3. Specifically, the processor 31 determines whether or not the data is stored in the first area 321. If the data is not stored in the first area 321, the processor 31 determines that the data of the integration source point card C1 is read at a first timing. If it is determined that the data of the integration source point card C1 is read (Yes in Act 3), the processor 31 stores the card ID included in the data of the integration source point card C1 in the first area 321 in Act 4. After that, the processor 31 returns to the processing in Act 2. In other words, the processor 31 stands by until the data of the point card C is read at a second timing after the first timing.

Here, if the data of the point card C is acquired again through the card reader interface 39 (Yes in Act 2), the processor 31 proceeds to the processing in Act 3. At this time, since the data is stored in the first area 321, the processor 31 determines that the data of a point card other than the integration source point card C1 is read. If it is determined that the data of the point card other than the integration source point card C1 is read (No in Act 3), the processor 31 determines whether or not the data of the integration object point card C2 is read in Act 5. Specifically, the processor 31 determines whether or not the card ID included in the data of the point card C read by the card reader 40 is coincident with the data stored in the first area 321. If the card ID is coincident with the data stored in the first area 321, the point card C read at the second timing is exactly the integration source point card C1 read at the first timing. In other words, the data of the integration object point card C2 is not read. If it is determined that the data of the integration object point card C2 is not read (No in Act 5), the processor 31 returns to the processing in Act 2.

If it is determined that the card ID is not coincident with the data stored in the first area 321, and that the data of the integration object point card C2 is read (Yes in Act 5), in Act 6, the processor 31 stores the card ID included in the data of the integration object point card C2 in the second area 322.

Here, the computer mainly composed of the processor 31 cooperates with the card reader interface 39 and the card reader 40 to execute the processing in Act 2 to Act 6 to function as a reading module.

Therefore, the operator first uses the card reader 40 to read the data of one of the two point cards, i.e., the integration source point card C1 received from the point member. Next, the operator uses the card reader 40 to read the data of the other of the two point cards, i.e., the integration object point card C2. By doing that, the card ID of the integration source point card C1 read at the earlier first timing is stored in the first area 321, and the card ID of the integration object point card C2 read at the later second timing is stored in the second area 322.

If the processing in Act 6 is terminated, the processor 31 generates an inquiry command including the card ID stored in the first area 321 in Act 7. Then, the processor 31 controls the communication interface 35 to transmit the inquiry command to the POS server 10. Through the control operation, the inquiry command including the card ID of the integration source point card C1 is transmitted to the POS server 10 via the network 20.

If the command transmitted via the communication interface 35 via the communication interface 35 is received, the processor 11 of the POS server 10 starts the reception interruption processing in FIG. 8. Specifically, the processor 11 determines whether or not the received command is the inquiry command in Act 31. If the received command is not the inquiry command (No in Act 31), the processor 31 confirms whether or not the received command is an update command in Act 32. If the received command is not the update command (No in Act 32), the processor 31 executes another processing.

If the received command is the inquiry command (Yes in Act 31), the processor 11 retrieves the point database 50 using the card ID included in the inquiry command in Act 33. Then, the processor 11 determines whether or not there is a point record 50R including the card ID in Act 34.

If the corresponding point record 50R is stored in the point database 50 (Yes in Act 34), the processor 11 acquires an accumulative point from the point record 50R in Act 35. Then, the processor 11 generates a normal response command including the accumulative point in Act 36. Then, the processor 11 controls the communication interface 15 to transmit the normal response command to the POS terminal 30 transmitting the inquiry command.

Here, the computer with the processor 11 as the central part cooperates with the communication interface 15 to execute the processing in Act 33 to Act 36 to function as a notifying module.

If the corresponding point record 50R is not stored in the point database 50 (No in ACT 34), the processor 11 executes another processing. For example, the processor 11 may generate an error response command, and then control the communication interface 15 to transmit the error response command to the POS terminal 30 transmitting the inquiry command.

Returning to the description of FIG. 6.

In Act 7, the processor 31 which controls the transmission of the inquiry command determines whether or not the normal response command is received in Act 8. If the normal response command transmitted via the communication interface 15 can be received within a predetermined period of time (Yes in Act 8), the processor 31 stores the accumulative point included in the normal response command in the third area 323 in Act 9.

Next, the processor 31 generates an inquiry command including the card ID stored in the second area 322 in Act 10. Then, the processor 31 controls the communication interface 35 to transmit the inquiry command to the POS server 10. Through the control operation, the inquiry command including the card ID of the integration object point card C2 is transmitted to the POS server 10 via the network 20.

At this time, the processor 11 of the POS server 10 executes the processing in Act 33 to Act 36 in FIG. 8 in the same manner as in the above case.

The processor 31 controlling the transmission of the inquiry command in Act 10 determines whether or not a normal response command is received in Act 11. If the normal response command through the communication interface 35 can be received within a predetermined period of time (Yes in Act 11), the processor 31 stores an accumulative point included in the normal response command in the fourth area 324 in Act 12.

Here, the computer with the processor 31 as the central part cooperates with the communication interface 35 to execute the processing in Act 7 to Act 12 to function as an acquiring module.

In ACT 8 or ACT 11, if the normal response command cannot be received within the predetermined period of time (No in ACT 8 or No in ACT 11), the processor 31 executes another processing. For example, the processor 31 may display a message indicating a card reading error on the display device 37.

If the processing in Act 12 is terminated, the processor 31 proceeds to the processing in FIG. 7. Specifically, the processor 31 adds up the accumulative point stored in the third area 323 and the accumulative point stored in the fourth area 324 in Act 13. Then, the processor 31 stores the total point in the sixth area 326 in Act 14. The processor 31 displays the total point on the display device 37 in Act 15.

Here, the computer with the processor 31 as the central part executes the processing in Act 13 to function as a calculation module.

As described above, in the POS terminal 30, the operator uses the card reader 40 to sequentially read the data of each of the integration source point card C1 and the integration object point card C2. Through the simple work, the total point obtained by adding up the accumulative point of the integration source point card C1 and the accumulative point of the integration object point card C2 is displayed on the display device 37. Therefore, the operator asks the point member about whether to integrate the point card C. If a reply that the point card C is to be integrated is obtained, the operator makes a selection input to integrate the point with the input device 36. On the other hand, if a reply that the integration of the point card C is to be canceled is obtained, the operator makes a selection input for not integrating the point with the input device 36. Specifically, the processor 31 displays two buttons “YES” and “NO” together with the total point on the display device 37. If the processor 31 detects that the “YES” button is pressed via the input device 36, the processor 31 determines that the execution of the point integration is selected. If the processor 31 detects that the “NO” button is pressed through the input device 36, the processor 31 determines that the cancellation of the point integration is selected.

If the processing in Act 15 is terminated, the processor 31 receives a selection input indicating whether to perform the point integration or to cancel the point integration in Act 16. If the selection input for canceling the point integration via the input device 36 is received (No in Act 16), the processor 31 terminates the processing. By terminating the processing, the total point displayed on the display device 37 is erased.

If the input for performing the point integration executed via the input device 36 is received (Yes in Act 16), the processor 31 generates an update command including the card ID stored in the second area 322 and the total point stored in the sixth area 326 in Act 17. Then, the processor 31 controls the communication interface 35 to transmit the update command to the POS server 10. Through the control operation, the update command including the card ID and the total point of the integration object point card C2 is transmitted to the POS server 10 via the network 20.

As shown in FIG. 8, if the processor 11 of the POS server 10 determines that the update command is received (Yes in Act 32), the processor 11 of the POS server 10 retrieves the point database 50 using the card ID included in the update command in Act 37. Then, the processor 11 determines whether there is a point record 50R including the card ID in Act 38.

If the corresponding point record 50R is stored in the point database 50 (Yes in Act 38), the processor 11 rewrites the accumulative point of the point record 50R with the point included in the update command, i.e., the total point in Act 39. Specifically, the processor 11 detects the point record 50R including the card ID included in the update command, i.e., the point record 50R of the integration object point card C2 from the point database 50. Then, the processor 11 rewrites the point in the point record 50R with the total point from the point before integration.

Here, the computer with the processor 11 as the central part executes the processing in Act 37 to Act 39 to function as a rewriting module.

If the processing in Act 39 is terminated, the processor 11 generates a normal response command indicating that the point update is normally performed in Act 40. Then, the processor 11 controls the communication interface 15 to transmit the normal response command to the POS terminal 30 transmitting the update command.

If the corresponding point record 50R is not stored in the point database 50 (No in Act 38), the processor 11 executes another processing. For example, the processor 11 generates an error response command, and controls the communication interface 15 to transmit the error response command to the POS terminal 30 transmitting the update command.

Returning to the description of FIG. 7.

In Act 17, the processor 31 controlling the transmission of the update command determines whether or not the normal response command is received in Act 18. Then, if the normal response command transmitted via the communication interface 35 can be received within a predetermined period of time (Yes in Act 18), the processor 31 sets the data in the fifth area 325 to zero point in Act 19. The processor 31 then generates an update command including the card ID stored in the first area 321 and the zero point stored in the fifth area 325 in Act 20. Then, the processor 31 controls the communication interface 35 to transmit the update command to the POS server 10. Through the control operation, the update command including the card ID and zero point of the integration source point card C1 is transmitted to the POS server 10 via the network 20.

At this time, the processor 11 of the POS server 10 executes the processing in Act 37 to Act 40 in FIG. 8 in the same manner as in the above case. Specifically, the processor 11 detects the point record 50R including the card ID included in the update command from the point database 50, i.e., the point record 50R of the integration source point card C1. Then, the processor 11 rewrites the point in the point record 50R with the zero point from the point before integration.

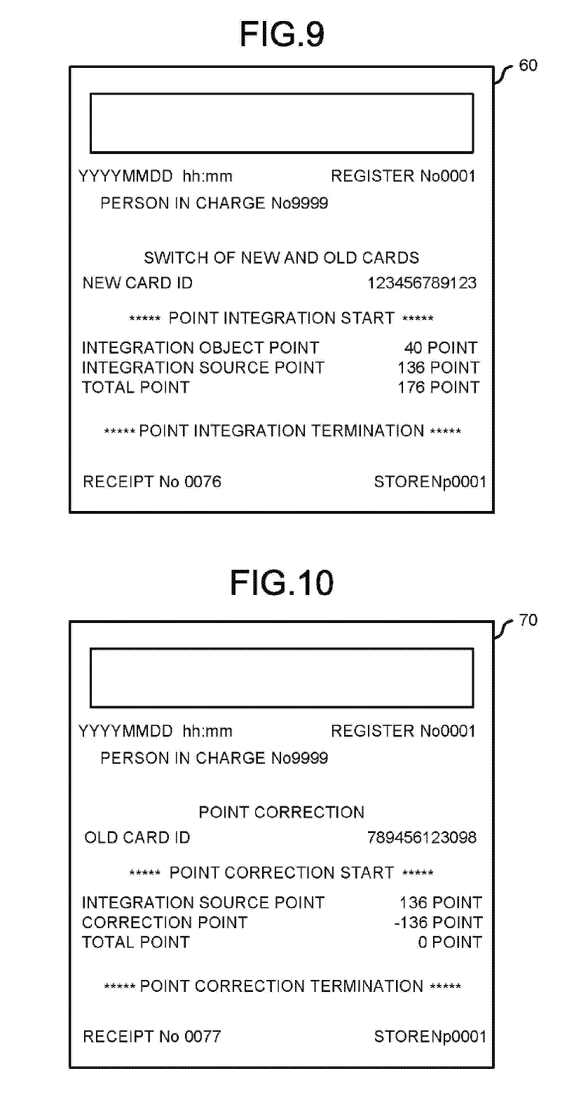

In Act 20, the processor 31 controlling the transmission of the update command determines whether or not the normal response command is received in Act 21. If the normal response command can be received within the predetermined period of time via the communication interface 35 (Yes in Act 21), the processor 31 controls the printer 38 to issue a customer reservation-oriented receipt 60 (refer to FIG. 9) in Act 22. The processor 31 controls the printer 38 to issue a store reservation-oriented receipt 70 (refer to FIG. 10) in Act 23. Thus, the processor 31 terminates the information processing by executing the point integration program.

FIG. 9 shows an example of the customer reservation-oriented receipt 60. The customer reservation-oriented receipt 60 together with the integration object point card C2 is handed over to the point member who completes the point integration for adding the point of the integration source point card C1 to the point of the integration object point card C2.

As shown in FIG. 9, on the customer reservation-oriented receipt 60, the card ID of the integration object point card C2 is printed as a new card ID. The accumulative point before the integration of the integration object point card C2 is printed as an integration object point, and the accumulative point before the integration of the integration source point card C1 is printed as an integration source point. Furthermore, the point after the integration of the integration object point card C2, i.e., the total point is printed as a total point. In addition, on the customer reservation-oriented receipt 60, a date and time at which the integration is performed, a register number for identifying the POS terminal 30, a number of a person in charge for identifying the operator, a receipt number for identifying the receipt, a store number for identifying the retail store, and the like are also printed.

FIG. 10 shows an example of the store reservation-oriented receipt 70. The store reservation-oriented receipt 70 is managed in the store together with the integration source point card C1.

As shown in FIG. 10, on the store reservation-oriented receipt 70, the card ID of the integration source point card C1 is printed as an old card ID. The accumulative point before the integration of the integration source point card C1 is printed as an integration source point, and a point obtained by adding a minus sign to the accumulative point is printed as a correction point. Furthermore, the point after the integration of the integration source point card C1, i.e., the zero point is printed as a total point. In addition, on the store reservation-oriented receipt 70, a date and time at which the integration is performed, a register number for identifying the POS terminal 30, a number of a person in charge for identifying the operator, a receipt number for identifying the receipt, a store number for identifying the retail store, and the like are also printed.

Returning to the description of FIG. 7.

If the normal response command cannot be received in Act 18, the processor 31 stores update data including the card ID and the accumulative point of the integration object point card included in the update command in a batch area in the main memory 32 in Act 24. Likewise, if the normal response command cannot be received in Act 21, the processor 31 also stores update data including the card ID and the zero point of the integration source point card included in the update command in the batch area in the main memory 32 in Act 24. In this manner, the update data stored in the batch area is transmitted to the POS server 10 as an update command by, for example, a batch processing which is automatically executed at a predetermined time.

Therefore, if the selection input for performing the point integration is carried out by the operator, the accumulative point stored in the point database 50 in association with the integration object point card C2 is updated to the point obtained by adding up the accumulative point of the integration source point card C1 and the accumulative point of the integration object point card C2. The accumulative point stored in the point database 50 in association with the integration source point card C1 is updated to zero point.

Here, the processor 31 cooperates with the communication interface 35 to perform the processing in Act 17 to Act 20 to function as an update module.

The processor 31 cooperates with the printer 38 to perform the processing in Act 22 and Act 23 to function as a printing module.

As described above, according to the POS system 1 of the present embodiment, by merely reading each of the data of the integration source point card C1 and the data of the integration object point card C2 once in the POS terminal 30, it is possible to integrate the point of the integration source point card C1 to the point of the integration object point card C2. At this time, since the operator does not need to input the total point which is the point after the integration of the integration object point card C2 and the zero point which is the point of the integration source point card C1, a point input mistake hardly occurs. Moreover, the operation on the input device 36 by the operator is limited to the selection operation for selecting whether to perform the point integration practically, which is very simple.

Since the point of the integration source point card C1 surely becomes zero point after the integration, the inconsistency of the total number of points in the whole system does not occur. Furthermore, the point of the integration source point card C1 becomes the zero point after the point of the integration source point card C1 becomes the total point. If an error occurs when updating the point of the integration source point card C1 and the update cannot be performed since the point of the integration source point card C1 is set to zero point before the point of the integration source point card C1 becomes the total point, the total number of points in the whole system is consistent. In the present embodiment, such a problem can also be avoided.

According to the present embodiment, the customer reservation-oriented receipt 60 can be issued from the POS terminal 30 to the point member who has completed the point integration for adding the point of the integration source point card C1 to the point of the integration object point card C2. On the customer reservation-oriented receipt 60, the card ID of the integration object point card C2, the points before and after the integration of the integration object point card C2, the point before the integration of the integration source point card C1, and the like are recorded. Therefore, it is possible to easily provide a voucher, on which appropriate information is recorded for the integration object point card C2 that the point member brings back after the integration, to the point member who requests the integration of the point card C.

According to the present embodiment, the store reservation-oriented receipt 70 can be issued from the POS terminal 30 to the operator who has completed the integration operation of the point card C. On the store reservation-oriented receipt 70, the card ID of the integration source point card C1, points before and after the integration of the integration source point card C1, and the like are recorded. Therefore, the store side can easily acquire a voucher in which appropriate information is recorded for the integration source point card C1 collected by the operator after the integration of the point card.

Although one embodiment of the point card integration apparatus and the point card integration system is described above, the embodiment is not limited thereto and various modifications can be made.

For example, in the above-described embodiment, the POS terminal 30 processes the point card read at the first timing by the reading module as the integration source point card C1, and processes the point card read at the second timing after the first timing as the integration object point card C2. However, the second timing may be earlier than the first timing. In other words, the point card previously read may be set as the integration object point card C2, and the point card read later may be set as the integration source point card C1. Also in this case, the operator can read the data of the integration object point card C2 first with the card reader 40 and then read the data of integration source point card C1 with the card reader 40, which is simple.

The POS terminal 30 may comprise a first reading module and a second reading module, and may process a point card read by the first reading module as the integration source point card C1 and may process a point card read by the second reading module as the integration object point card C2. In this case, the reading order of the point card using the first reading module and the second reading module is not particularly limited. The point cards may be read by the first reading module and the second reading module at the same time.

In the above embodiment, two point cards of the same type are integrated. However, for example, by providing two sets of storage areas composed of the first area 321 and the third area 323, it is possible to integrate three point cards. Specifically, in Act 3 in FIG. 6, it is determined that the integration source point cards C1 are read until card IDs thereof are respectively stored in the two first areas 321, and it is determined that the integration object point card C2 is read after the card ID thereof is stored. Then, in the processing subsequent to Act 7, the same processing is repeatedly performed for each first area 321 in the processing relating to the first areas 321. By doing this, it is possible to integrate three point cards. Furthermore, it is possible to integrate four or more point cards in the same way.

In the above embodiment, after reading the data of the integration source point card C1 and the integration object point card C2, the points before the integration of the integration source point card C1 and the integration object point card C2 are acquired from the POS server 10. However, for example, after acquiring the point before the integration of the integration source point card C1, the data of the integration object point card C2 may be read. In the above embodiment, the point before the integration of the integration source point card C1 is acquired first, and the point before the integration of the integration object point card C2 is acquired later, but the order thereof may be reversed.

In the above embodiment, the POS terminal 30 drives the printer 38 to issue the customer reservation-oriented receipt 60 and the store reservation-oriented receipt 70. However, since the effect of integrating the points of a plurality of point cards on one point card without mistakes can be achieved in a simple operation even if there is not the function of issuing the customer reservation-oriented receipt 60 and the store reservation-oriented receipt 70, the printer 38 may be not provided. The POS terminal 30 may be configured to output the data in the first to sixth areas 321 to 326 to a controller of a printer which is an external device of the POS terminal 30 so that the printer can issue the customer reservation-oriented receipt 60 and the store reservation-oriented receipt 70.

In the above embodiment, the POS terminal 30 operated by the store clerk is used as the point card integration apparatus. The POS terminal 30 may be a self-service type POS terminal operated by the customer. The point card integration apparatus is not necessarily limited to the POS terminal 30. By installing the point card integration program of the present embodiment, an information processing apparatus connected with a card reader of the point card C may be used as the point card integration apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A point card integration apparatus, comprising:
a reading module configured to read an integration source point card and an integration object point card;
an acquiring module configured to acquire retained points stored respectively in association with the integration source point card and the integration object point card read by the reading module;
a calculation module configured to calculate a total point value obtained by adding the retained points of the integration source point card and the retained points of the integration object point card which are acquired by the acquiring module; and
an update module configured to update the retained points associated with the integration object point card with the total point value, and then to set the retained points associated with the integration source point card to zero points.

2. The point card integration apparatus according to claim 1, further comprising:
a printing module configured to print a voucher indicating that the retained points associated with the integration object point card is updated with the total point value by the update module.

3. The point card integration apparatus according to claim 2, wherein
the printing module further prints a voucher indicating that the retained point associated with the integration source point card is set to zero points by the update module.

4. The point card integration apparatus according to claim 1, wherein
a point card read at a first timing by the reading module is processed as the integration source point card, and a point card read at a second timing different from the first timing is processed as the integration object point card.

5. The point card integration apparatus according to claim 1 comprised in a POS system.

6. A point card integration system comprising a server which manages a point database for storing a retained point value in association with a point card and a point card integration apparatus comprising a reading module for reading the point card,
the server comprising:
a notifying module configured to retrieve the point database and to notify the point card integration apparatus of a retained point value of a point card if an inquiry command of the point card is received from the point card integration apparatus; and
a rewriting module configured to retrieve the point database and to rewrite a retained point value of a point card with an updated point value if an update command including the updated point value of the point card is received from the point card integration apparatus, and
the point card integration apparatus comprising:
an acquiring module configured to transmit the inquiry command of the point card read by the reading module to the server, and to acquire retained points notified from the server as retained points of the integration source point card or retained points of the integration object point card;
a calculation module configured to calculate a total point value obtained by adding the retained points of the integration source point card and the retained points of the integration object point card which are acquired by the acquiring module; and
an update module configured to transmit the update command comprising the total point value as the updated point value of the integration object point card to the server, and then to transmit the update command comprising the zero points as the updated point value of the integration source point card to the server.

7. The point card integration system according to claim 6, further comprising:
a printing module configured to print a voucher indicating that the retained points associated with the integration object point card is updated with the total point value by the update module.

8. The point card integration system according to claim 7, wherein
the printing module further prints a voucher indicating that the retained point associated with the integration source point card is set to zero points by the update module.

9. The point card integration system according to claim 6, wherein
a point card read at a first timing by the reading module is processed as the integration source point card, and a point card read at a second timing different from the first timing is processed as the integration object point card.

10. A POS system comprising the point card integration system according to claim 6.

11. The POS system according to claim 10 further comprising a sales transaction module.

12. A method for integrating point cards by a point card integration apparatus comprising a reading module for reading an integration source point card and an integration object point card, comprising:
acquiring retained points stored respectively in association with the integration source point card and the integration object point card read by the reading module;
calculating a total point value obtained by adding the acquired retained points of the integration source point card and the acquired retained points of the integration object point card; and
updating the retained points associated with the integration object point card to the total point value, and then setting the retained points associated with the integration source point card to zero points.

13. The method according to claim 12, further comprising:
printing a voucher indicating that the retained points associated with the integration object point card is updated with the total point value by the update module.

14. The method according to claim 13, further comprising:
printing a voucher indicating that the retained point associated with the integration source point card is set to zero points by the update module.

15. The method according to claim 12, further comprising:
processing a point card read at a first timing as the integration source point card, and processing a point card read at a second timing different from the first timing as the integration object point card.

16. The method according to claim 12, further comprising:
performing a sales transaction before the acquiring act or after the updating act.

17. The method according to claim 16, further comprising:
printing a sales receipt indicating sales transactions and indicating that the retained points associated with the integration object point card is updated with the total point value by the update module.

18. The method according to claim 17, further comprising:
printing the sales receipt further indicating that the retained point associated with the integration source point card is set to zero points by the update module.
